(19) United States
(12) Patent Application Publication
(10) Pub. No.: US 2012/0255300 A1
(43) Pub. Date: Oct. 11, 2012

(54) SOLAR THERMAL POWER PLANT AND METHOD FOR OPERATING A SOLAR THERMAL POWER PLANT

(76) Inventors: Jürgen Birnbaum, Nurnberg (DE); Peter Gottfried, Erlangen (DE); Zsuzsa Preitl, Erlangen (DE); Frank Thomas, Erlangen (DE)

(21) Appl. No.: 13/518,099

(22) PCT Filed: Dec. 1, 2010
(86) PCT No.: PCT/EP10/68618

§ 371 Date: Jun. 21, 2012

(30) Foreign Application Priority Data
Dec. 22, 2009 (DE) 10 2009 060 091.4

(51) Int. Cl. F03G 6/00

(52) U.S. Cl. 60/641.8

(57) ABSTRACT

A solar thermal power plant including a solar collector steam generator unit for generating steam, a solar collector steam superheater unit for superheating the steam, and a steam turbine is provided. The solar thermal power plant includes an intermediate storage which is connected to the steam conduit system in a first high-temperature storage connecting point interposed between the solar thermal steam superheater unit and the steam turbine to remove steam superheated in a storage mode from the steam conduit and which includes a heat reservoir in which thermal energy is drained from the steam fed into during the storage mode and is accumulated and the stored thermal energy is given off to the steam in an extraction mode, steam being fed to the steam conduit system from the intermediate storage. The intermediate storage is connected to a condenser and/or a relaxation device of the plant in a low-temperature storage connecting point.

### CROSS REFERENCE TO RELATED APPLICATIONS

This application is the US National Stage of International Application No. PCT/EP2010/068618, filed Dec. 1, 2010 and claims the benefit thereof. The International Application claims the benefits of German application No. 10 2009 060 091.4 DE filed Dec. 22, 2009. All of the applications are incorporated by reference herein in their entirety.

### FIELD OF INVENTION

The invention relates to a solar thermal power plant comprising a solar collector steam generator unit for generating steam, a solar collector steam superheater unit which is connected downstream of the solar collector steam generator unit and is used for superheating the steam, and a steam turbine that is connected to an outlet of the solar collector steam superheater unit via a steam conduit system and is supplied with the superheated steam during operation. The invention further relates to a method for operating such a solar thermal power plant.

### BACKGROUND OF INVENTION

Solar thermal power plants represent an alternative to conventional power generation. Solar thermal power plants are currently realized using parabolic fluted collectors and indirect evaporation by means of an additional oil circuit. Solar thermal power plants featuring direct evaporation are being developed for future use. A solar thermal power plant featuring direct evaporation can consist of one or more solar fields, for example, each comprising a plurality of parabolic fluted collectors and/or Fresnel collectors, in which the supply water that has been pumped in is first preheated and vaporized and the steam is then superheated. The superheated steam is supplied to a conventional power plant part, in which the thermal energy of the steam is converted into electrical energy. In this case, provision is advantageously made for the water to be initially preheated and vaporized in first solar fields comprising a plurality of parallel strings of parabolic fluted collectors and/or Fresnel collectors (also referred to below as “evaporator solar fields”). The generated steam or water-steam mixture is then routed to a steam separator, in order to separate off the remaining unvaporized water. The steam is then routed onwards into the solar collector steam superheater units. The solar collector steam superheater units can be individual solar collectors, a plurality of parallel solar collector strings, or solar fields consisting of a plurality of solar collector strings.

In the power plant part, the superheated steam coming from the solar collector steam superheater units is supplied to a turbine, which drives a generator. During the subsequent cooling in a condenser, the steam is converted back into water, which is collected in a supply water container and fed to the solar fields via the supply water pump. In order to utilize the energy more efficiently, the power plant part may comprise not just one turbine, but a plurality of turbines that are connected one behind the other relative to the steam transport direction, e.g. a high-pressure turbine into which the live steam is first routed, and a medium-pressure and/or low-pressure turbine, in which the steam coming from the high-pressure turbine is used again.

The operation of a turbine is usually subject to strict temperature limits, in order to achieve the longest possible service life at a maximal level of efficiency. If the steam temperature drops too much, the efficiency level is reduced. Conversely, a temperature that is too high can damage the turbine and shorten its service life. A typical temperature range is between 390 and 500° C., wherein the steam pressure can lie between 41 and 140 bar. These parameters can vary from installation to installation depending on component layout. However, the problem remains that the temperature of the live steam supplied to the turbine should be kept as stable as possible and should not suffer from significant fluctuations. It is therefore necessary to realize a suitable live steam temperature control, which is able to maintain the live steam temperature at a constant desired value even during non-steady operation, i.e. when the output of the power plant varies.

A steam temperature control can be achieved by means of steam cooling devices (e.g. in the region of the solar collector) that cool the steam, which is initially superheated above the actually desired temperature, to the required temperature. Injection coolers are typically used for this purpose, injecting precisely defined quantities of water into the steam and thereby cooling it. Other steam cooling devices admix colder steam. Depending on the thermal input and/or load condition, the quantity of the cooling medium can be decreased or increased in order to maintain the desired temperature.

Under extreme circumstances, however, such as those that are entirely possible during non-steady operation of solar thermal power plants, a constant live steam temperature cannot always be guaranteed using the existing injection system, since the steam cooling devices go beyond their control range in extreme cases. If a large area of cloud moves across the solar field, for example, the live steam temperature cannot be maintained due to the sudden decrease in thermal input, even if the injection coolers are closed completely. It is also difficult or impossible to manage such a situation using the supply water control, since this has a considerably slower dynamic response in comparison with injection coolers or other steam cooling devices.

Preliminary plans currently include suitable thermal long-time storage entities for solar thermal power plants. These storage entities will be charged by means of taking live steam from the main circuit of the solar field. However, this means that there will be less steam available to flow through the turbine. Conversely, however, the thermal energy that is available in the storage can be used if necessary to provide an additional quantity of steam and thereby compensate for a temporary output drop, e.g. due to a short-term partial or total failure of the solar fields as a result of shading. An important question concerning the realization of such intermediate storage concepts is how the energy can be stored as effectively and for as long as possible in the storage and how it can be retrieved from the storage with minimal losses.

### SUMMARY OF INVENTION

The present invention therefore addresses the problem of improving a solar thermal power plant and a method for operating a solar thermal power plant as cited in the introduction by means of an intermediate storage concept, whereby particularly effective intermediate storage of energy and withdrawal of the stored energy become possible.

This problem is solved by a solar thermal power plant according to the claims and by a method according to the claims

For this purpose, a solar thermal power plant as described in the introduction inventively features an intermediate storage, which is connected to the steam conduit system at at least a first high-temperature storage connecting point that is interposed between the solar collector steam superheater unit and the steam turbine, in order to extract superheated steam from the steam conduit system during a storage mode. This intermediate storage comprises a heat store, in which thermal energy from the steam that was fed in during the storage mode is drawn off and stored. In an extraction mode, the stored thermal energy is released into the steam that is supplied from the intermediate storage to the steam conduit system. At a low-temperature storage connecting point, the intermediate storage is inventively connected to a condenser and/or relaxation device of the solar thermal power plant. The connections to the high-temperature storage connecting point and the low-temperature storage connecting point can preferably be effected by means of a storage connection valve device comprising one or more valves.

In the inventive method for operating the solar thermal power plant, provision is made accordingly for some of the superheated steam to be routed into the intermediate storage (featuring the heat store) at a high-temperature storage connecting point during a storage mode. Thermal energy is drawn from the steam and stored in said heat store. At a low-temperature storage connecting point, the cooled steam or a water/steam mixture that is produced in this case is supplied to a condenser and/or a relaxation device. During the extraction mode, water and/or steam is supplied to the intermediate storage at a (preferably different) low-temperature storage connecting point and the stored thermal energy is released back into the water or steam and the superheated steam that is generated in this way is supplied directly or indirectly to the steam turbine.

Using this construction and operation, it is therefore possible to route new superheated steam continuously into the intermediate storage at the high-temperature storage connecting point during the storage mode. Since the heat store is not normally able to absorb thermal energy at a constant rate over the whole duration of the storage mode, the temperature and pressure conditions can change at the end of the heat store on the low-temperature side as a function of the duration of the storage mode, i.e. after energy has already been absorbed by the heat store, and water, steam or a water/steam mixture can occur there depending on the conditions at the time. According to the invention, the intermediate storage is therefore also connected at a low-temperature storage connecting point (preferably directly but also indirectly if applicable, i.e. via further components) to a condenser and/or a relaxation device of the solar thermal power plant. The relaxation device can be e.g. a relaxation container or similar, in which the pressurized steam or the water/steam mixture is relaxed atmospherically, for example. According to the invention, it is also possible in the context of a suitable layout to use a supply water container as a relaxation device for carrying away the medium at the end of the intermediate storage on the low-temperature side in this case. In particular, a relaxation container can preferably be connected between the outlet on the low-temperature side of the intermediate storage and the condenser. This is particularly advantageous if it is stipulated by the manufacturer of the condenser system that only liquid medium should enter the condenser from such a secondary line. The supply line to a condenser or to a relaxation device has the advantage that, irrespective of the temperature and pressure ratios and irrespective of the state of aggregation of the medium (water and/or steam) at the outlet of the intermediate storage, the medium can be carried away and supplied back to the water/steam circuit of the solar thermal power plant. Very high thermal charging of the heat store is therefore possible. This means that the intermediate storage can be brought to a higher temperature level overall than in the case of a design in which e.g. only one storage operation is possible, as long as the absorption capacity of the heat store is sufficient to convert the steam completely into the liquid phase and add the condensed water to the supply water. Conversely, during the extraction mode a greater quantity of energy or thermal energy can then be extracted from the intermediate storage at a comparatively higher temperature level, such that the live steam temperature can also be better utilized during full-load operation of the solar field.

During the extraction mode, supply water can be drawn off from the supply water line in particular, wherein said supply water is first vaporized and then superheated in the thermally highly charged heat store, the stored thermal energy being released during this process, such that the superheated steam can be supplied back to the steam conduit system at a high-temperature storage connecting point. For this purpose, the intermediate storage can preferably by connected to the supply water line via a valve at a low-temperature storage connecting point. If there is a normal pressure difference between the supply water line and the live steam line, during the extraction mode the water flows into the intermediate storage automatically and then back into the live steam line as steam.

The storage mode is therefore advantageously selected when the solar thermal power plant operating output is excessive, i.e. the solar collector field delivers more steam output than is required. The extraction mode is selected when the solar thermal power plant operating output is inadequate, i.e. when the solar collector field delivers less steam output than is actually required. The capacity of the solar field in such an installation, i.e. the capacity of the solar collector steam generator unit(s) and of the solar collector steam superheater unit(s), can obviously be so dimensioned as to be greater than is required during normal average operation, in order thus to provide sufficient capacity to top up the intermediate storage during the storage mode.

In addition to increasing output in the short-term or sustaining the live steam temperature, the intermediate storage can also be used during periods of low insolation, in particular during the evening and at night, in order to continue to generate steam and to produce current even during these times by means of the solar thermal power plant.

The dependent claims and the following description contain particularly advantageous embodiments and developments of the invention, it being explicitly noted that the inventive method can also be developed in accordance with the dependent claims relating to the solar thermal power plant and vice versa.

Depending on the current temperature and pressure conditions at the low-temperature side of the storage, the cooled and possibly even partially or fully condensed steam can be fed back into the water/steam circuit of the solar thermal power plant at least occasionally, including at other suitable points. For this purpose, the intermediate storage is preferably connected at further low-temperature storage connecting points to different lines and/or other components in the line system of the solar thermal power plant.

Moreover, the intermediate storage can preferably also be connected at various low-temperature storage connecting points (via valves that can be activated) to various steam lines, in which steam is carried at different temperatures or pressures during operation. The connection to the various steam lines at the various low-temperature storage connecting points is advantageously effected via suitable valves, which can be activated individually. The connection of the intermediate storage via various low-temperature storage connecting points to a condenser or a relaxation device and/or to various steam lines is particularly helpful for the case in which the heat store cannot draw sufficient energy from the steam due to its design, or because it is already so heavily charged, and therefore the steam condenses completely. If there are connections to various steam lines carrying steam at different temperatures and pressures, it is then always possible e.g. to open the valve to the steam line in which steam having the appropriate steam temperature range and the appropriate pressure range is being carried. The steam or the water/steam mixture can then be utilized further at the appropriate points in the circuit without any loss of energy. In this case, at least some of the low-temperature storage connecting points are preferably arranged in outlet steam lines of a steam turbine and/or at least some of the low-temperature storage connecting points are connected to heat exchangers. The medium coming from the intermediate storage can therefore also be used for regenerative preheating of supply water. If the pressure and/or temperature ratios at the end of the storage on the low-temperature side are not suitable for any of the connected steam lines or other components, the steam or the water/steam mixture is inventively supplied to the relaxation container or the condenser.

If the heat store is designed such that the steam is generally condensed during the storage mode, at least when the thermal charging of the storage is not yet very far advanced, the intermediate storage is preferably also connected to a supply water line at the low-temperature storage connecting point, wherein the water that is present in the intermediate storage is routed via said supply water line to the solar collector steam generator unit as supply water. In this case, it is particularly preferable for the intermediate storage to be connected to the supply water line via a pump at the low-temperature storage connecting point. Here again, the connection is preferably effected via valves that can be activated. The pump can preferably also be activated by a control device which is suitable for the valves.

In a particularly preferred exemplary embodiment of the solar thermal power plant, a steam cooling device (subsequently also referred to as “final-stage steam cooling device”) is arranged in the steam conduit system between the above cited high-temperature storage connecting point, at which the steam is routed into the intermediate storage, and the steam turbine. In addition, the solar thermal power plant preferably features a control device which is so designed as to regulate the temperature of the superheated steam to a turbine live steam temperature during operation, i.e. the steam is first superheated in the solar collector steam superheater unit to a steam superheater final temperature, this being higher than the turbine live steam temperature, and then cooled down to the turbine live steam temperature by means of the final-stage steam cooling device.

In a corresponding preferred operating method, the temperature of the superheated steam is therefore regulated (e.g. after measuring a current actual temperature) to give a predefined turbine live steam temperature (desired temperature), i.e. the steam is first superheated to a steam superheater final temperature, this being higher than the turbine live steam temperature, and then cooled down to the turbine live steam temperature by regulation in a steam cooling device that is arranged behind the solar collector steam superheater unit.

If the high-temperature storage connecting point at which the steam is routed into the intermediate storage lies upstream (in the direction of flow) of the steam cooling device in which the temperature of the live steam is regulated down to the value required by the turbine, the steam that is used to charge the storage is extracted from the main steam circuit at the point which has the highest steam temperature. It is therefore also possible for steam that has a higher temperature than the required live steam temperature to be fed back from the intermediate storage during the extraction mode, such that the storage can be used not only to provide additional steam, but also to counteract a temperature drop in the steam coming from the solar collector steam superheater unit, i.e. to compensate for the temperature drop by introducing a hotter steam. By virtue of the additional admixture of steam of a higher temperature in the inventive manner, it is therefore possible (even if a final-stage steam cooling device is fully deactivated, i.e. the injection fixture is closed) to maintain the live steam temperature at a constant level within specified limits, even if the steam delivered by the solar collector steam superheater unit is lower than the live steam temperature. This means that the live steam temperature for the turbine can more easily be kept within predefined limits even in the case of a partial output of the solar collector steam generator unit and/or of the solar collector steam superheater unit. The availability and operational flexibility of the entire solar thermal power plant is therefore increased.

In the simplest and particularly preferred variant of this arrangement featuring the final-stage steam cooling device, the supply of the steam from the intermediate storage into the steam conduit system during the extraction mode preferably takes place in this case at the first high-temperature storage connecting point itself, i.e. at the same connecting point at which the steam is supplied to the storage during the storage mode. The final-stage steam cooling device, which is already arranged within the steam conduit system, can therefore also be used to cool down the superheated steam that comes from the intermediate storage during the extraction mode to the appropriate live steam temperature.

The arrangement has a further advantage in that, in the event of a short-term demand for output reserves (so-called “seconds reserve”), the thermal energy stored in the long-term storage can be used for additional steam production even if there is no drop in the temperature of the steam coming from the solar collector steam superheater unit, and it is merely necessary to increase the steam quantity for the purpose of increased output. The additionally generated steam can then be admixed with the main steam stream in the steam conduit system again before the final-stage steam cooling device, and brought to the live steam temperature in the cooling device. As a result of the advantageous coupling of the intermediate storage to the steam conduit system before the final-stage steam cooling device, it is easily possible to ensure a constant live steam temperature during the provision of seconds reserve.

By virtue of the final temperature level of the exit steam from the intermediate storage being higher than the required live steam, the steam cooling device is also able to maintain the live steam temperature for longer in an operating mode during which steam continues to be generated and current produced in periods of low insolation, e.g. during the evening. A live steam temperature drop which is managed by the steam cooling device and accepted by the turbine would likewise be possible using this arrangement, e.g. if the intermediate storage is to be emptied during nighttime operation.

In another variant of this arrangement, the superheated steam is supplied to the steam conduit system from the intermediate storage at a second high-temperature storage connecting point, this being arranged in the steam conduit system between the “final-stage steam cooling device” and the turbine. In this case, a steam cooling device should preferably by arranged likewise in the supply line from the intermediate storage to the second high-temperature storage connecting point of the steam conduit system, in order thus separately to cool the superheated steam coming from the intermediate storage (which should of course have a higher temperature than the live steam temperature) to the live steam temperature. Such a further supply line to the second high-temperature storage connecting point and a second steam cooling device admittedly incur additional costs, but the temperature of the steam from the intermediate storage can be regulated separately and independently of the main steam stream flowing through the final-stage steam cooling device, and therefore this variant can also be beneficial depending on the other design-related specifications of the installation.

During the storage mode, the intermediate storage is preferably connected to the steam conduit system between the solar collector steam superheater unit and the steam turbine by means of opening a valve, wherein in a preferred variant the opening of the valve is regulated as a function of a predefined desired value for a mass flow in the steam conduit system ahead of the steam turbine. In another preferred variant, the opening of the valve is regulated to give a constant pressure ahead of the steam turbine.

During the extraction mode, the intermediate storage is likewise connected to the steam conduit system between the solar collector steam superheater unit and the steam turbine by means of opening a valve, the opening of the valve however being preferably regulated here to give a constant temperature in the steam conduit system at the high-temperature storage connecting point. If the feeding in of the steam from the intermediate storage takes place at the first high-temperature storage connecting point (i.e. ahead of the final-stage steam cooling device), at which the steam is also routed from the steam conduit system into the storage, it is thus possible to ensure that the temperature is already maintained at a value that is as constant as possible ahead of the last steam cooling device, such that no great regulation variations occur in the context of the temperature control using the final-stage steam cooling device.

The heat store can be constructed differently.

For example, the heat store can be constructed such that the thermal energy is stored or released again by virtue of a phase transition of a storage medium, i.e. use can be made of a so-called PCM storage (PCM=Phase Change Material). The heat storing medium of a PCM storage can consist of salts or already liquefied salts, for example. A phase change of the salts between a solid and a liquid state, or of the liquefied salts between a liquid and a gaseous state, is used to store thermal energy in this case. Conversely, thermal energy is released again in the case of a phase transition from gaseous to liquid or liquid to solid. The heat transfer between the steam and the storage medium can take place within a heat exchanger, for example, preferably in a tube register.

Alternatively or additionally, the intermediate storage can also comprise at least one heat store, in which the thermal energy is stored or released by a storage medium without phase transition. For example, high-temperature concrete can be used as a storage medium here. These types of storage likewise allow the heat transfer to take place in a heat exchanger, preferably within a tube register. High-temperature concrete materials that work in the range of up to 400° C. already exist. Other materials, which work in the range of up to 500° C., are being developed.

In a particularly preferred exemplary embodiment, the intermediate storage comprises the same number of storage stages for absorbing and releasing thermal energy. It is particularly preferred in this case if at least two of the storage stages are functionally different in their construction. For example, this means that one storage stage is constructed as PCM storage while another storage stage comprises a heat store in which the thermal energy is stored without phase transition.

In a variant of an intermediate storage comprising a plurality of storage stages, the steam is condensed in one of the storage stages during the storage mode, and the water is also vaporized again in this storage stage during the extraction mode depending on the operating state of the installation, e.g. in the case of reduced load with lower pressure. In particular, in the case of such a construction, the storage stages are preferably so arranged as to be functionally parallel with the solar collector steam generator unit and the subsequent solar collector steam superheater unit. This means that e.g. the intermediate storage is so arranged as to be parallel with the solar fields (in the manner of a type of bypass between the supply water feed line and the steam conduit system ahead of the turbine) and is stepped in a similar way to the individual stages in the solar fields. In this case, a storage stage in which steam is condensed during the storage mode and water is vaporized during the extraction mode is arranged parallel with the solar collector steam generator units, and the storage stages which cool down the superheated steam during the storage mode and/or superheat the steam again during the extraction mode are then arranged parallel with the solar collector steam superheater units. In this case, the condensation of the steam in the final storage stage on the low-temperature side is clearly only possible if steam coming from the preceding storage stage has already been adequately cooled and the final storage stage is still able to draw sufficient energy from the steam. Due to the inventive coupling of the intermediate storage on the low-temperature side to a condenser or a relaxation device and optionally further connecting points, the water and/or the steam can however be fed back on the low-temperature side to the water/steam circuit of the solar thermal power plant as explained above, irrespective of the temperature and pressure ratios and irrespective of the state of aggregation.

### BRIEF DESCRIPTION OF THE DRAWINGS

The invention is explained in greater detail below with reference to exemplary embodiments and to the appended drawing.

The sole FIGURE shows a schematic block diagram of a solar thermal power plant in accordance with a preferred exemplary embodiment of the invention.

### DETAILED DESCRIPTION OF INVENTION

In this case, the figure shows a highly simplified illustration of a solar thermal power plant featuring direct evaporation. Said solar thermal power plant has a solar collector steam generator unit 2 comprising a plurality of solar collector strings for vaporizing the supply water which is supplied via a supply water line. Connected downstream of the solar collector steam generator unit 2 is a solar collector steam superheater unit 4 likewise comprising a plurality of solar collector strings for superheating the steam that is generated by the solar collector steam generator unit 2. Between the solar collector steam generator unit 2 and the solar collector steam superheater unit 4 is a steam separator 3, in which any residual water still in the steam is separated off and fed back to the supply water line 10 via a return line 11 and a pump 9. The steam coming from the solar collector steam superheater unit 4 is supplied via a steam conduit system 13 to a high-pressure turbine 40. A shut-off valve or turbine regulating valve 18 is situated ahead of the turbine inlet 41. The turbine 40 is connected via a driveshaft 45 to a transmission 46, which is in turn connected to a generator 62 in order to convert the kinetic energy of the driveshaft into electrical energy.

The steam that is used in the high-pressure turbine 40 is then routed in stages at various outlets of the high-pressure turbine 40 into outlet steam lines 42, 43, 44 that lead to heat exchangers 47 by means of which the supply water for the solar collector steam generator unit 2 can be preheated. Part of the steam from the outlet steam line 44 is also supplied to a turbine inlet 56 of a low-pressure turbine 50, in order to utilize the steam further for conversion into electrical energy. A driveshaft 53 of this low-pressure turbine 50 is likewise connected to the generator 62 for this purpose. The steam line to the turbine inlet 56 features both a separator 52 for separating off condensed water, and a heat exchanger 51 in which the steam is heated again (reheated) before being supplied to the low-pressure turbine 50. The pressure at the entrance of the low-pressure turbine 50 can be regulated via a valve 54 ahead of the turbine inlet 56. In order for the steam for the low-pressure turbine 50 to be supplied with further thermal energy in the heat exchanger 51, the latter is subjected to a flow of steam which is branched via a branch valve 48 in a branch line 49 from the superheated steam which is itself intended for the high-pressure turbine 40. The steam coming from the branch line 49 condenses in the heat exchanger 51 in this case and is supplied via a line 55 via the heat exchanger 47 to a supply water container 63.

The low-pressure turbine 50 also has a plurality of outlets at various turbine stages, said outlets being connected to outlet steam lines 57, 58, 59, 60, 61. One outlet steam line 57 leads to the supply water container 63.

A further outlet steam line 61, which is located at the very end of the low-pressure turbine 50 (i.e. the line having the lowest steam pressure), leads to a condenser 65 that is connected via a further heat exchanger 67 to a cooling tower 68. The residual steam condenses to water in this condenser 65 and is supplied via a pump 69 to the supply water container 63. On its way there, it can pass through a plurality of heat exchangers 70, which are supplied with residual steam from the low-pressure turbine 50 via the outlet steam lines 58, 59, 60. The residual steam likewise condenses to water in these heat exchangers 70, wherein said water is mixed with the condensed water in the condenser 65 at the mixing point 66 and is supplied again via the pump 69 through the heat exchanger 70 to the supply water container 63. The water is therefore effectively condensed and maintained at a high temperature (below the steam temperature), without wasting the thermal energy in the residual steam.

The supply water container 63 also receives the water that is condensed in the other heat exchangers 51, 47. The supply water is then fed back via a supply water line 10 by means of a supply water pump 64 to the solar collector steam generator unit 2, in order thus to close the circuit.

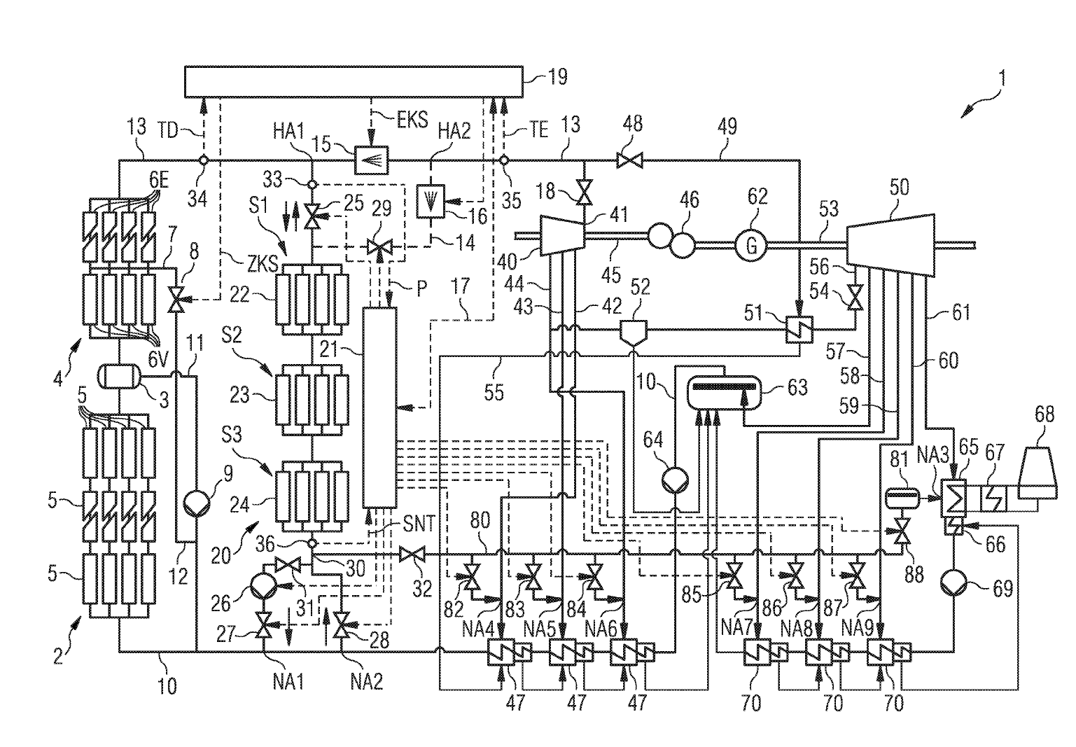

As mentioned above, the solar collector steam generator unit 2 here consists of a plurality of strings of individual solar collectors 5. According to the invention, these can be parabolic fluted collectors or Fresnel collectors, for example. Only four strings are shown here, each comprising three collectors 5. In reality, such a solar thermal power plant would have a multiplicity of further solar collector strings comprising a significantly higher number of solar collectors. In this case, a plurality of collector strings are optionally combined into groups to form spatially discrete solar fields, and the steam generated there is mixed downstream of the solar fields before entering the solar collector steam superheater units. In this way, the individual solar fields for steam generation can be assigned their own solar fields for superheating the steam in each case. In other words, a plurality of groups of solar collector steam generator units 2, each group having solar collector steam superheater units 4 connected downstream as illustrated for such a group in FIG. 1, are connected in parallel and supplied via one or more supply water lines 10, and the superheated steam is ultimately mixed in a mixing zone in the steam conduit system 13 ahead of the high-pressure turbine 40.

The solar collector steam superheater unit 4 also consists of a plurality of solar collector strings, each comprising a plurality of solar collectors 6V, 6E. The solar collectors 6V are primary superheater solar collectors 6V (referred to simply as “primary superheaters” below) and the solar collectors 6E are final-stage superheater solar collectors 6E (referred to simply as “final-stage superheaters” below).

Injection coolers are situated between the primary superheaters 6V and the final-stage superheaters 6E, and are schematically illustrated by an injection point 7 here. Water is injected at this point 7 for the purpose of cooling, in order thus to regulate the output temperature TD at the end of the final-stage superheaters 6E (i.e. the steam superheater final temperature TD) to a predefined value.

To this end, use is made of a control device 19 that inter alia receives a steam superheater final temperature TD which is measured as a current actual temperature at a temperature measuring point 34 downstream of the final-stage superheater 6E, and regulates it to a predefined desired temperature by sending a temporary injection control signal ZKS to a regulating valve 8, which regulates the water supply to the injection coolers at the injection point 7. In principle, each collector string can be regulated separately if the injection coolers of the collector strings are supplied via valves that can be activated separately in each case. The cooling water can be extracted e.g. via a cooling water line 12 which is situated downstream of the pump 9 for returning the condensed water from the water separator 3. The control device 19 can feature one or more regulating systems (not shown) for this purpose, wherein these can be realized either discretely in the form of individual electronic components or integrated in a computer in the form of software.

This control device 19 can also receive further measured data from the overall line system, e.g. the current pressure in the solar collector steam generator unit, in the solar collector steam superheater unit or in the steam conduit system ahead of the turbine 40. The desired temperature to which the steam superheater final temperature TD is regulated should always be higher than the actually required live steam temperature for the steam turbine 40. In order to bring the steam temperature to the required live steam temperature, a final-stage steam cooling device 15 (a further injection cooler 15 in this case) is situated in the steam conduit system 13 between the outlet of the solar collector steam superheater unit 4 and the inlet 41 of the steam turbine 40. Said injection cooler 15 is likewise activated by the control unit 19 by means of a final spray control signal EKS, which can again be done e.g. by activating a valve via which the injection cooler 15 is supplied with cooling water (not shown). In the following, the final-stage steam cooling device 15 is also referred to simply as “final-stage injector”, without thereby limiting the invention to necessarily comprising a steam cooling device in the form of an injection cooler.

For the purpose of regulating the temperature, a further actual temperature (specifically the current live steam temperature TE here) is measured at a temperature measuring point 35 downstream of the final-stage injector 15 and compared with a desired temperature value, i.e. with the desired value of the live steam temperature which is required here for the turbine 40 and is received by the control device 19 as predefined by the block control unit of the turbines, for example. The final-stage injector 15 is then activated accordingly.

According to the invention, the steam conduit system 13 also features a high-temperature storage connecting point HA1 ahead of the final-stage injector 15, wherein an intermediate storage 20 is connected at said high-temperature storage connecting point HA1 via a valve 25 that can be regulated.

This intermediate storage 20 consists of a plurality of storage stages S1, S2, S3 comprising different heat stores 22, 23, 24, which are connected one behind the other in a chain.

The individual heat stores 22, 23, 24 can be constructed differently and can also function differently. In the present case, all of the heat stores 22, 23, 24 are storage entities of the type that draw thermal energy for storage from the medium that passes through them, or release thermal energy into the medium that passes through them as required. In this case, they can be e.g. heat stores that function without a phase change of the energy-storing medium, e.g. solid storage such as high-temperature concrete storage, or PCM storage comprising storage media that undergo a phase change when energy is stored. One such example is a storage entity containing liquefied salt as a storage medium that performs a phase change into a gaseous state for the purpose of energy storage. In the case of the exemplary embodiment illustrated in the figure, e.g. the heat stores 22, 23 of the first two storage stages S1, S2 are constructed as storage that does not undergo a phase change, and the heat store 24 in the storage stage S3 is designed as PCM storage. However, other arrangements are also possible in principle.

On the side of the intermediate storage 20 that is remote from the high-temperature connecting point HA1 at the last storage stage S3, the intermediate storage 20 is connected to the supply water line 10 at two low-temperature connecting points NA1, NA2. The connection to the first low-temperature storage connecting point NA1 is effected by means of a first valve 31, a pump 26 and a second valve 27. A parallel connection to a second low-temperature storage connecting point NA2 is effected by means of a third valve 28 only, i.e. without the interconnection of a pump.

The intermediate storage 20 on the low-temperature side is additionally connected at a branch point 30 by means of a fourth valve 32 to a line 80 that leads to a low-pressure storage connecting point NA3 at the condenser 65 of the power plant. A relaxation container 81 is connected ahead of the condenser 65 in this case, and the medium coming from the line 80 from the intermediate storage is atmospherically relaxed therein. In the case of installations where the pressure and temperature levels at which the medium is supplied to the condenser 65 are irrelevant, this relaxation container 81 can also be omitted. The line 80 to the relaxation container 81 or to the condenser 65 can be shut off by means of a further valve 88.

At various low-pressure storage connecting points NA4, NA5, NA6, NA7, NA8, NA9, the line 80 is connected to different steam lines within the power plant block via valves 82, 83, 84, 85, 86, 87 that can be activated separately. In the exemplary illustration, some of the low-temperature storage connecting points NA4, NA5, NA6 are situated respectively in the various outlet steam lines 42, 43, 44 of the high-pressure turbine 40, and other low-temperature storage connecting points NA7, NA8, NA9 are situated in the various outlet steam lines 58, 59, 60 of the low-pressure turbine 50, wherein said outlet steam lines 42, 43, 44, 58, 59, 60 lead to the heat exchangers 47, 70 for the supply water 10.

All of the valves 27, 28, 31, 32, 82, 83, 84, 85, 86, 87, 88 on the low-temperature side of the intermediate storage 20, and the valve 25 on the high-temperature side of the intermediate storage 20, are activated by a storage control device 21. The latter also receives a further input signal representing a temperature SNT of the steam, this being measured at a temperature measuring point 36 on the low-temperature side of the intermediate storage 20. This storage control device 21 is also in contact with the control device 19 via a communication connection 17, such that these two control devices 19, 21 function in a coordinated manner Alternatively, the storage control device 21 can also be designed as a subcomponent of the control device 19.

The way in which the intermediate storage 20 functions during operation of the solar thermal power plant 1 illustrated in the figure is e.g. as follows:

During a storage mode, superheated steam which is not required for the steam turbine is supplied from the steam conduit system 13 to the intermediate storage 20 in order therein to store as much thermal energy as possible. To this end, the first valve 27 is opened at the low-temperature storage connecting point NA1 and the pump 26 is started. At the same time, the valve 25 at the high-temperature storage connecting point HA1 is opened in a regulated manner, wherein regulation of the opening position of the valve 25 is preferably effected as a function of mass flow. A mass flow measuring device required for this purpose is provided accordingly (not shown in the figure). However, pressure-regulated opening of the valve 25 is also conceivable, such that the pressure within the steam conduit system 13 remains as constant as possible. For this purpose, the pressure p is measured at a pressure-measuring point 33 and sent to the storage control device 21, such that the valve 25 can be regulated accordingly. This can be coordinated with existing pressure regulation by means of the steam turbine valve if applicable.

Superheated steam therefore flows via the valve 25 into the first storage stage

Si first, where it releases heat into the medium of the heat store 22. The steam cools in this way, and then reaches the second storage stage S2. The steam releases heat again in the heat store 23 of this second storage stage S2. The cooled steam then reaches the third storage stage S3. The steam liquefies here first, i.e. at the beginning of the storage mode, while releasing considerable heat into the storage medium of the heat store 24, which—as explained above—is constructed e.g. as a PCM heat store featuring a phase-changing medium that converts from a liquid into a gaseous state when it absorbs the thermal energy. The water that is produced in this way in the intermediate storage 20 is added to the supply water line 10 via the pump 26 and the valve 27.

As the duration of the storage mode progresses, the intermediate storage 20 becomes heavily charged with thermal energy, and the final storage stage S3 on the low-temperature side can no longer able draw so much heat from the supplied steam that it condenses fully. A water/steam mixture is then present.

On the basis of the temperature SNT at the end of the intermediate storage 20 on the low-temperature side, this state can be detected by the storage control device 21. The valves 27, 31 to the first low-temperature storage connecting point NA1 are then closed and the pump 26 is stopped, and instead the valve 32 to the line 80 and the valve 88 ahead of the relaxation container 81 are opened. The water/steam mixture is thermally relaxed in the relaxation container 81 and then routed to the condenser 65 at the third low-temperature storage connecting point NA3. It is again noted that the relaxation container 81 ahead of the condenser 65 is optional, and that the water/steam mixture can also be routed to the condenser 65 directly if the condenser 65 is configured correspondingly.

Later in the storage mode, the intermediate storage 20 is finally so thermally charged that the supplied steam no longer condenses, and almost pure steam is present at the end of the intermediate storage 20 on the low-temperature side. On the basis of the temperature SNT at the end of the intermediate storage 20 on the low-temperature side, and optionally an additional pressure measurement (not shown), the storage control device 21 can check whether the temperature and the pressure of the steam on the low-temperature side of the intermediate storage 20 corresponds approximately to the temperature and the pressure in one of the steam lines 42, 43, 44, 58, 59, 60 of the further low temperature connecting points NA4, NA5, NA6, NA7, NA8, NA9. If so, the valve 88 ahead of the relaxation container 81 or the condenser 65 is closed again and the corresponding valve 82, 83, 84, 85, 86, 87 is opened on the low-temperature side. If the pressure and/or temperature ratios are not suitable for any of the lines 42, 43, 44, 58, 59, 60, the valve 88 ahead of the relaxation container 81 or the condenser 65 simply remains open or is opened if it was previously closed.

Using this construction, the intermediate storage 20 overall can be brought up to a higher temperature level that in the case of a design in which only one storage operation is possible, provided the absorption capacity of the final storage stage S3 is sufficient to convert the steam completely into the liquid phase. In this case, the storage mode can be continued until the heat store 20 is fully charged, i.e. until it cannot absorb any more thermal energy. The storage mode can then be switched on again briefly at intervals in order to compensate for heat losses in the heat stores.

Provision is preferably made for defining a maximal steam temperature, with which the temperature SNT at the end of the intermediate storage 20 on the low-temperature side is compared. If this maximal steam temperature is reached, any further flow through the intermediate storage 20 is prevented (e.g. by closing the valve 25) and the intermediate storage 20 is considered to be fully charged Important criteria for determining the maximal steam temperature can be process-related requirements, for example, such as e.g. reliable, optimally efficient and cost-effective operation of the intermediate storage 20 in connection with the regenerative supply water preheaters or the condensed water system, as well as safety requirements relating to the materials used for the connection lines and fixtures.

This process takes place in reverse during an extraction mode. Such an extraction mode is activated e.g. when the solar fields comprising the solar collector steam generator units 2 and solar collector steam superheater unit 4 are not able to reach a steam superheater final temperature TD which is higher than the required live steam temperature for the turbine 40. In this case, the second valve 28 at the second low-temperature storage connecting point NA2 is opened and the valve 25 at the high-temperature storage connecting point HA1 is again opened in a regulated manner, wherein this is now effected not as a function of the pressure however, but as a function of the temperature, such that the temperature at the high-temperature storage connecting point HA1 is maintained at a constant value above the live steam temperature that is actually required. The exact adjustment of the live steam temperature then takes place as usual via the final-stage injector 15.

Water is therefore drawn from the supply water line 10 during this extraction mode. In the case of a normal pressure difference between the supply water line 10 (e.g. 50-145 bar) and the steam conduit system 13 (e.g. 41-110 bar), it is anticipated that no pump will be required for water to flow into the intermediate storage 20 and for steam to be extracted during the extraction mode. In the third storage stage S3, this water is preheated to boiling temperature by drawing the heat from the PCM heat store 24, vaporized and supplied to the second storage stage S2, where the water initially undergoes primary superheating by likewise drawing the heat from the heat store 23 and is then supplied to the storage stage 51. Final-stage superheating of the steam takes place there by drawing the heat from the heat store 22, such that a steam superheater final temperature TD is reached that is sufficiently high.

The workflow of the intermediate storage 20 therefore follows the same functional sequence as occurs in the solar collector steam generator unit 2 and the subsequent solar collector steam superheater unit 4 that are connected in parallel with said intermediate storage 20, this being clearly visible in FIG. 1.

In addition to the solar collector strings and solar fields illustrated here, the whole solar thermal power plant 1 can obviously feature not only further solar fields, which are connected in parallel in each case and supply superheated steam to the steam conduit system 13 ahead of the turbine 40, but also a plurality of parallel storage entities 20, which can also be operated separately as required in the various operating modes.

Also marked in the figure is an optional bypass 14 from the end of the intermediate storage 20 on the high-temperature side to a high-temperature connecting point HA2 downstream of the final-stage injector 15. This bypass 14 is opened by means of a separate valve 29. Downstream of this valve 29 is a separate bypass injection cooler 16 for reducing the temperature of the steam coming from the intermediate storage 20. The additional bypass injection cooler 16 is likewise activated by the control device 19 and the valve 29 is activated by the storage control device 21. This bypass 14 can be used during the extraction mode in such a way that the superheated steam is not fed into the steam conduit system 13 ahead of the final-stage injector 15 via the valve 25, but instead steam that has already been set to exactly the desired live steam temperature is delivered to the turbine 40 via the valve 29 and the additional bypass injection cooler 16.

Finally, it is again noted that the methods described in detail above and the solar thermal power plant are merely preferred exemplary embodiments which can be modified in the widest possible variety of ways by a person skilled in the art without thereby departing from the scope of the invention as specified in the claims. In particular, further low-temperature storage connecting points to various other steam lines can be provided. These can also already be supplied with a water-steam mixture under suitable preconditions (pressure and temperature). When a flow medium is fed into one or more steam lines, it is likewise possible for e.g. surplus flow medium (which can or should no longer be received by the steam lines) to be drained into the relaxation device and/or the condenser in parallel. Moreover, it is also possible for the intermediate storage 20 on the low-temperature side to be connected directly to the supply water container 63. In particular, the intermediate storage 20 can also be so constructed as to include any desired number of further storage stages, or in principle to consist of just a single storage stage. Furthermore, any other directly or indirectly functioning solar collectors can be used instead of the cited parabolic fluted collectors or Fresnel collectors. In particular, use is possible in conjunction with the new solar tower technology featuring direct evaporation. The above cited temperature and pressure ranges must likewise be considered as merely exemplary and not restrictive. The maximal temperatures and pressures at which the invention can be used are largely dictated by the storage types and storage materials that are available.

For the sake of completeness, it is also noted that the use of the indefinite article “a” or “an” does not exclude the possibility of multiple instances of the features concerned. Likewise, the term “unit” does not exclude the possibility that this may consist of a plurality of components which can also be spatially distributed if applicable.

1-15. (canceled)

16. A solar thermal power plant, comprising:
a solar collector steam generator unit for generating steam;
a solar collector steam superheater unit, connected downstream of the solar collector steam generator unit, for superheating the steam;
a steam turbine which is connected via a steam conduit system to an outlet of the solar collector steam superheater unit and is supplied with the superheated steam during operation; and
an intermediate storage, which is connected to the steam conduit system at least at a first high-temperature storage connecting point that is arranged between the solar collector steam superheater unit and the steam turbine, in order to extract superheated steam from the steam conduit system during a storage mode, and
wherein the intermediate storage comprises a heat store in which thermal energy from the steam that was fed in during the storage mode is drawn off and stored and in which the stored thermal energy is released into steam that is supplied from the intermediate storage to the steam conduit system in an extraction mode, and which is connected at a first low-temperature storage connecting point to a condenser and/or a relaxation device of the solar thermal power plant.

17. The solar thermal power plant as claimed in claim 16, wherein the intermediate storage is connected at a plurality of further low-temperature storage connecting points to a plurality of steam lines, into which steam is supplied at different temperatures and/or pressures during operation.

18. The solar thermal power plant as claimed in claim 16, wherein the intermediate storage is connected at a second low-temperature storage connecting point to a supply water line, via which supply water is routed to the solar collector steam generator unit during the extraction mode.

19. The solar thermal power plant as claimed in claim 16, wherein the intermediate storage is connected to the supply water line at a third low-temperature storage connecting point via a pump.

20. The solar thermal power plant as claimed in claim 16, wherein in the steam conduit system a steam cooling device is arranged between the high-temperature storage connecting point and the steam turbine,
wherein the solar thermal power plant features a control device which is so designed as to regulate the temperature of the superheated steam to a turbine live steam temperature during operation,
wherein the steam is first superheated in the solar collector steam superheater unit to a steam superheater final temperature, this being higher than the turbine live steam temperature, and then cooled down to the turbine live steam temperature by means of the steam cooling device,
wherein a portion of the superheated steam is routed into the intermediate storage at the first high-temperature storage connecting point during a storage mode.

21. The solar thermal power plant as claimed in claim 20, wherein superheated steam from the intermediate storage is supplied to the steam conduit system at the first high-temperature storage connecting point during an extraction mode.

22. The solar thermal power plant as claimed in claim 20,
wherein a second high-temperature storage connecting point is arranged between the first high-temperature storage connecting point and the steam turbine,
wherein superheated steam from the intermediate storage is supplied to the steam conduit system at the second high-temperature storage connecting point during an extraction mode.

23. The solar thermal power plant as claimed in claim 16, wherein the intermediate storage comprises at least one heat store in which the thermal energy is stored or released again by means of a phase transition of a storage medium.

24. The solar thermal power plant as claimed in claim 16, wherein the intermediate storage comprises at least one heat store in which the thermal energy is stored or released again by a storage medium without phase transition.

25. The solar thermal power plant as claimed in claim 16, wherein the intermediate storage comprises a plurality of storage stages for absorbing and releasing thermal energy.

26. The solar thermal power plant as claimed in claim 25, wherein at least two of the storage stages are constructed differently.

27. The solar thermal power plant as claimed in claim 25, wherein in one of the storage stages the steam is at least partially liquefied at least occasionally during the storage mode and water is vaporized at least occasionally during the extraction mode.

28. The solar thermal power plant as claimed in claim 25, wherein the plurality of storage stages are so constructed as to be functionally parallel with the solar collector steam generator unit and the subsequent solar collector steam superheater unit.

29. A method for operating a solar thermal power plant that features a solar collector steam generator unit for vaporizing water, a solar collector steam superheater unit for superheating the steam, and a steam turbine which is supplied with the superheated steam during operation, the method comprising:
routing a portion of the superheated steam into an intermediate storage at a high-temperature storage connecting point during a storage mode;
drawing off and storing thermal energy from steam in a heat store disposed in the intermediate storage; and
supplying the cooled steam or a water/steam mixture arising to a condenser and/or a relaxation device at a first low-temperature storage connecting point,
wherein water and/or steam is supplied to the intermediate storage at a second low-temperature storage connecting point during an extraction mode and the stored thermal energy is released back into the water and/or the steam, and the superheated steam thus generated is supplied to the steam turbine.

30. The method as claimed in claim 29,
wherein the temperature of the superheated steam is regulated to give a predefined turbine live steam temperature,
wherein to this end the steam is first superheated to a steam superheater final temperature, this being higher than the turbine live steam temperature, and then cooled down to the turbine live steam temperature in a steam cooling device which is arranged downstream of the solar collector steam superheater unit,
wherein a portion of the superheated steam is routed into the intermediate storage ahead of the steam cooling device during a storage mode, and
wherein superheated steam is extracted from the intermediate storage ahead of and/or downstream of the steam cooling device during an extraction mode.

31. The method as claimed in claim 29,
wherein the intermediate storage is connected to a steam conduit system between the solar collector steam superheater unit and the steam turbine during the storage mode by means of opening a valve, and
wherein the opening of the valve is regulated as a function of a predefined desired value for mass flow in the steam conduit system ahead of the steam turbine.

32. The method as claimed in claim 29,
wherein the intermediate storage is connected to a steam conduit system between the solar collector steam superheater unit and the steam turbine during the extraction mode by means of opening a valve, and
wherein the opening of the valve is regulated to give a constant temperature at a high-temperature storage connecting point in the steam conduit system.
